(19) United States
(12) Patent Application Publication
(10) Pub. No.: US 2008/0265060 A1
(43) Pub. Date: Oct. 30, 2008

(54) Device and Spray Head for Stomising a Cosmetic Liquid

(76) Inventors: Reiker Canfield, Crystal Lake, IL (US); Bernhard Jasper, Waltrop (DE); Reinhard Neuhaus, Hemer (DE); Detlef Schmitz, Unna (DE); Jacques Achille Blanie, Unna (DE)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 10/597,365

(22) PCT Filed: Dec. 6, 2004
(86) PCT No.: PCT/EP04/13843

§ 371 Date: Jun. 4, 2007

(30) Foreign Application Priority Data
Jan. 21, 2004 (DE) 10 2004 003 266.1

(51) Int. Cl. B05B 9/04; B65D 83/28; B65D 88/54; B05B 1/00

(52) U.S. Cl. 239/373; 222/401; 222/325; 239/589

(57) ABSTRACT

A device and a spray head for atomizing a cosmetic fluid by with an electrically operable compressed air generator. In order to permit atomization of the fluid largely without any delay, an intermediate store for the fluid is arranged above and/or directly next to a nozzle. When the device is switched off, some fluid remains in the intermediate store so that, immediately after the compressed air feed is switched on, initially, fluid is transported from the intermediate store into the nozzle and is atomized, at least until a feed of fluid from the reservoir takes place.

### BACKGROUND OF THE INVENTION

1. Field of the Invention

The present invention relates to a device for atomizing a preferably cosmetic fluid a reservoir for the fluid that has an electrically operable compressed air generator for providing compressed air; and a nozzle, which is arranged above the reservoir in which it is possible for the fluid to be fed to the nozzle and atomized, preferably continuously, by means of the compressed air, in particular, it being possible for the entire fluid or the reservoir to be put under pressure by the compressed air. The invention also relates to a spray head for atomizing a preferably cosmetic fluid having a preferably single feed connection for feeding the fluid, a compressed air connection; and a nozzle which is arranged above the feed connection with which it is possible for the fluid to be atomized, preferably continuously, by means of the compressed air in the nozzle

2. Description of Related Art

German Patent Application DE 40 20 967 A1 corresponding to U.S. Pat. No. 5,192,009, which forms the starting point of the present invention, discloses a device for spraying fluids having an air pump which can be electrically controlled by means of a switch. The fluid to be sprayed is accommodated in a container. The fluid can be fed via a dip tube to a nozzle arranged above, in that compressed air generated by the air pump acts on the surface of the fluid. In addition, compressed air can be fed directly to the nozzle, in order to achieve spraying or nebulizing of the fluid as it leaves the nozzle.

In the case of the known device, after it is switched on, it is first necessary for liquid to be transported from the container, via the dip tube, to the nozzle before fluid is actually sprayed. This may take a relatively long time, in particular, after a prolonged period in which the device has not been used and when the container has been partly or almost completely emptied.

### SUMMARY OF THE INVENTION

The present invention is based on the object of providing a device and a spray head for spraying a cosmetic fluid so as to permit more convenient use, in particular, such that, when the device is used, fluid atomization and discharge takes place almost immediately.

The above object is achieved by a device and a spray head according to the invention as is described herein.

One fundamental idea of the present invention is that of arranging an intermediate store for the fluid above the nozzle, in which a certain amount of fluid remains when the device is not in use. Therefore, when the device is used, liquid can be sprayed immediately from the nozzle, initially from the intermediate store, until further liquid to be sprayed can be fed from the reservoir—via the intermediate store or else directly. This allows much more convenient use, since the spraying or atomizing operation can begin almost immediately after the device is switched on.

If need be, transport of liquid from the reservoir may take place only after actually use, in order then to refill the intermediate store.

The device or spray head is preferably formed in such a way that, when the device or spray head is switched off, the fluid remaining in the intermediate store does not run out via the nozzle or flow back again into the reservoir. Therefore, it can be ensured in a simple way that there is an adequate amount of fluid in the intermediate store when the device is next used.

Further advantages, features, properties and aspects of the present invention will be apparent from the following description of a preferred embodiment with reference to the accompanying drawings.

### BRIEF DESCRIPTION OF THE DRAWINGS

FIG. 1 is a schematic partial sectional representation of the device for atomizing a cosmetic fluid in accordance with the invention, and

FIG. 2 is an enlarged sectional representation of a spray head of the device.

### DETAILED DESCRIPTION OF THE INVENTION

In the figures, the same designations are used for the same or similar parts, and even if they are not described again, corresponding or comparable properties and advantages are achieved.

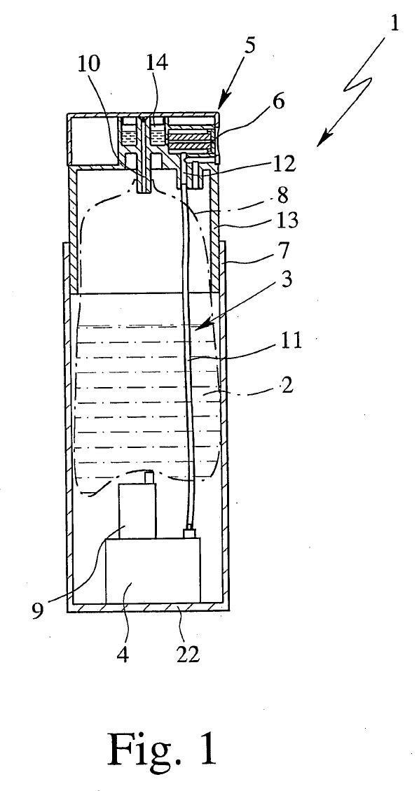

FIG. 1 shows, in a partial sectional representation, a proposed device 1 for atomizing a cosmetic fluid 2, such as hairspray, hair lacquer, a deodorant, a paint spray, a sunscreen or skincare agent or the like. However, the device 1 may also serve for atomizing some other fluid 2, such as rust penetrating agents. In particular, the fluid 2 can be atomized by the device 1 by means of compressed air into particles that, preferably, are approximately 30 to 50 μm, the fluid 2 not containing any propellant gas. In particular, the device 1 operates without propellant gas.

The device 1 has a reservoir 3 for the fluid 2, an electrically operable compressed air generator 4 for providing compressed air and a spray head 5—raised slightly in FIG. 1—with a nozzle 6.

The reservoir 3 for receiving the fluid 2 is preferably formed by a container 7, the receiving space formed therein or a bag 8, a cartridge or the like, arranged, in particular, in the device 1. If the bag 8 is used, it is sufficient if compressed air acts on the bag 8 from outside in order to transport fluid 2 from the bag 8 to this spray head 5 or to its nozzle 6. The fluid 2 can accordingly be kept and stored in the bag virtually with the exclusion of air. This is advantageous, in particular, with regard to a long shelf life and/or for fluids 2 that are sensitive to air.

According to a modification, the device 1 or its container 7 can be refilled with the fluid 2. As an alternative or in addition, the container 7 or the bag 8 can be exchanged.

In the case of the example represented, the compressed air generator 4 is preferably arranged within a housing of the device 1. However, preferably, the compressed air generator 4 is not in direct contact with the fluid 2.

The compressed air generator 4 is, preferably, formed as a pump, micropump, compressor, fan, turbine or the like. The compressed air generator 4, preferably, sucks in ambient air, which—optionally transported by forced conveyance—is compressed and then used as compressed air for transporting and atomizing the fluid 2.

The compressed air generator 4, preferably, operates electrically, being supplied with energy, in particular, from an energy store 9, such as a battery or a storage battery.

If a storage battery is used for supplying energy, it can preferably be charged by means of a charger (not represented), in particular, contactlessly, preferably inductively. This allows a high degree of operational reliability, in particular, if the device 1 is used in a damp area, such as a bathroom or the like.

As an alternative or in addition, the storage battery may also be rechargeable by means of a solar cell (not represented) of the device 1. As an alternative or in addition, however, it is also possible for the device 1 to be supplied with energy by means of a power supply cable or a wireless energy transmission. In this case, a storage battery is not absolutely necessary.

In the case of the example represented, the device 1 is portable and is formed, in particular, in a substantially cylindrical shape—with a circular, elliptical or other base area—or in a prismatic shape with any desired base area and/or preferably standing upright.

The fluid 2 can be fed from the reservoir 3 via a feed connection 10 to the spray head 5 or its nozzle 6. In the case of the use of a bag 8, as represented, a dip tube (Dot represented in FIG. 1), extending into the reservoir 3—in particular, as far as its bottom region—such as a hose or the like, is not absolutely necessary, but is preferably provided. Such a dip tube is then connected to the feed connection 10 for the fluid 2.

The compressed air generator 4 is preferably connected, or can be connected, to the spray head 5, in particular, a compressed air connection 12 of the spray head 5, via a flexible line 11, such as a hose or the like, schematically indicated in FIG. 1.

In the case of the example represented, the container 7 forms a housing part, in particular, a lower part, of the device 1. As an alternative, however, the container 7 may also be formed in the device 1, or be insertable into it, with the device 1 having a housing that is independent of it, and determining the outer contour of the device 1.

According to a modification, the spray head 5 is detachable from the container 7 or the lower part with the compressed air generator 4—in particular, for refilling the fluid 2 and/or exchanging the bag 8. In this case, the line 11 is, preferably, made long enough to permit refilling of fluid 2, for example, or exchange of the bag 8 or some other cartridge or the like, without having to interrupt the compressed air connection between the compressed air generator 4 and the compressed air connection 12 via the line 11.

The spray head 5 is, preferably, connected to the lower part or the container 7 in a latching manner or in a positively or nonpositively locking manner. The spray head 5 engages in the container 7 with a collar 13, in order to connect the spray head 5 to the container 7.

The device 1, in particular, the spray head 5, has an intermediate store 14 for the fluid 2, which is arranged above the nozzle 6 and is connected to the latter. Fluid 2 from the reservoir 3 can be fed to the intermediate store 14 via the feed connection 10. The device 1 or the spray head 5 is formed in such a way that, when the device 1 is switched off, a predetermined amount of fluid 2 remains in the intermediate store 14.

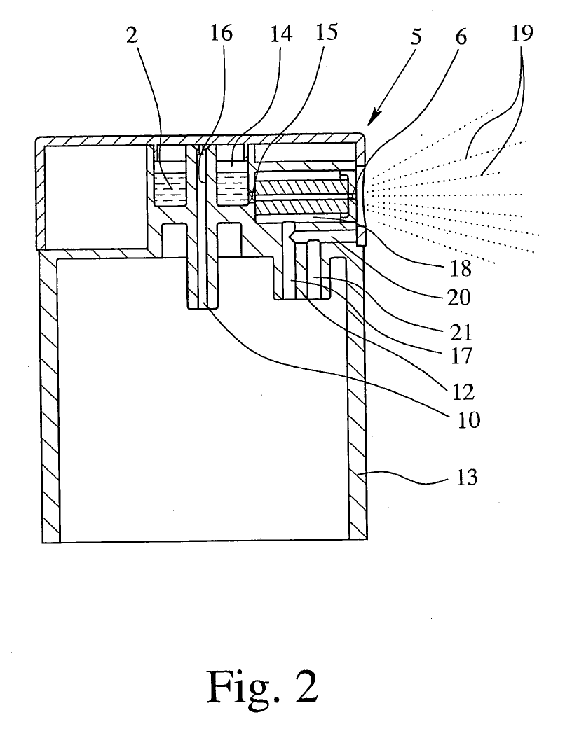

In particular, arranged between the intermediate store 14 and the nozzle 6 is a run-out preventer 15, which, or the preferred position of which, is only schematically indicated in FIG. 2. The run-out preventer 15 has, in particular, a suitable valve and/or a dip tube or the like (not represented). In particular, the run-out preventer 15 has a valve (the details of which are not represented), which opens when a predetermined pressure is exceeded, so that fluid 2 can then flow out of the intermediate store 14 to the nozzle 6 and be atomized there.

Therefore, the run-out preventer 15 prevents undesired running out of fluid 2 from the intermediate store 14 through the nozzle 6 when the device 1 is switched off and ensures that fluid 2 remains in the intermediate store 14.

The device 1 or the spray head 5, preferably, has a check valve (not represented) or a dip tube 16, in order to prevent fluid 2 from the intermediate store 14 from flowing back into the reservoir 3. This ensures that, even when the device 1 is switched off, a certain amount of fluid 2 remains in the intermediate store 14.

To use the device 1, a switch or the like (not represented) is actuated. In particular, the switch is integrated in the spray head 5 or attached to it, so as to permit intuitive actuation, for example by pressing the spray head 5, and resultant actuation of the switch.

The actuation has the effect of switching on the compressed air generator 4, which feeds compressed air to the spray head 5 via the compressed air connection 12. Channels 17 and 18 conduct the compressed air to the nozzle 6, where the compressed air escapes as a spray jet 19, schematically indicated in FIG. 2. A negative pressure sufficient to suck in fluid 2 from the intermediate store 14 is thereby generated in the nozzle 6, so that this fluid 2 is directly sprayed, virtually immediately after switching on or with only a minimal time delay.

Compressed air for transporting fluid 2 from the reservoir 3 is branched off from the compressed air connection 12 via channels 20 and 21—and if appropriate, via a restrictor (not represented) or a valve (not represented). This compressed air may act on the surface of the fluid 2 or if appropriate from outside on the bag 8.

On account of the arrangement of the intermediate store 14 directly next to and/or above the nozzle 6, the transport and atomization of fluid 2 from the intermediate store 14 can begin virtually without any delay, even when transport of fluid 2 from the reservoir 3 has not yet taken place. Rather, an adequate pressure must first be built up and be exerted on the fluid 2 in the reservoir 3, in order then to bring about transport of the fluid 2 into the intermediate store 14 and via the intermediate store 14 to the nozzle 6—as provided in the example represented—or directly from the feed connection 10 to the nozzle 6, according to an alternative that is not represented. Therefore, the proposed solution leads to a much more convenient handling and operation of the device 1, since atomization and discharge of liquid 2 can take place virtually immediately after switching on.

According to a modification, the volume of the intermediate store 14 for the fluid 2 is made large enough that, during normal use, only fluid 2 from the intermediate store 14 is atomized. This makes it possible that, during normal use, no compressed air is used for transporting fluid 2 from the reservoir 3, whereby the pressure and volumetric flow of compressed air available for the atomization is much greater with the same output of the compressed air generator 4.

In the case mentioned, refilling of the intermediate store 14 then takes place after completion of normal use of the device 1, in particular automatically. Preferably, the device 1 or the spray head 5 has the required valves (not represented) for this purpose, in order to use the desired optional feeding of the compressed air to the nozzle 6, on the one hand, and to transport fluid 2 from the reservoir 3 into the intermediate store 14. The device 1 is, preferably, formed in such a way that at least 0.2 g/s, in particular, 0.3 to 0.5 s, of fluid 2 can be discharged and atomized. Furthermore, the device 1 is, preferably, formed in such a way that at least 2 l/min, in particular, approximately 3 to 5 l/min, of air or aerosol mixture can be discharged from the device 1 or the spray head 5 as a spray jet 19.

In order to achieve a favorable weight distribution, the compressed air generator 4 and/or the energy store 9 is or are preferably arranged in a lower region, in particular alongside a base or standing area 22 of the device 1. As an alternative, however, the compressed air generator 4 may also be arranged directly alongside the spray head 5 or be integrated in it.

A device 1 and a spray head 5 for atomizing a preferably cosmetic fluid 2 by means of an electrically controllable compressed air generator 4 are proposed. In order to permit atomization of the fluid 2 largely without any delay, an intermediate store 14 for the fluid 2 is arranged above and/or directly next to a nozzle 6.

According to the proposal, the entire amount of fluid or the reservoir 3 is preferably put under pressure by the compressed air.

In the ease of the proposed device 1 or with the proposed spray head 5, a continuous discharge or atomization of fluid 2 is preferably possible.

The spray head 5 preferably has only a single feed connection 10 for feeding fluid 2.

1-20. (canceled)

21. Device for atomizing a preferably cosmetic fluid, having;
a reservoir for the fluid;
a nozzle, which is arranged above the reservoir;
an electrically operable compressed air generator means for providing compressed air in a manner causing the fluid to be fed to the nozzle and atomized by means of the compressed air; and
an intermediate store for the fluid which is arranged in proximity to the nozzle and is connected to the nozzle and to which fluid from the reservoir can be fed, the store being constructed and arranged in a manner causing fluid to remain therein when the compressed air generator means is switched off.

22. Device according to claim 21, wherein the reservoir is refillable.

23. Device according to claim 21, wherein the reservoir is exchangeable.

24. Device according to claim 21, wherein the reservoir is formed as a container or bag.

25. Device according to claim 21, wherein the compressed air generator means is constructed so as to suck in and compress ambient air.

26. Device according to claim 21, wherein the device has an energy store for supplying the compressed air generator with electrical energy.

27. Device according to claim 21, wherein a run-out preventer is arranged between the intermediate store and the nozzle for preventing fluid from running out from the intermediate store through the nozzle when the device is switched off.

28. Device according to claim 27, wherein the run-out preventer comprises a valve which opens automatically by pressure.

29. Device according to claim 27, wherein the run-out preventer has a dip tube for the fluid in the intermediate store.

30. Device according to claim 21, wherein the device has a at least one of a check valve and a dip tube for preventing fluid from the intermediate store from flowing back into the reservoir.

31. Device according to claim 21, wherein the compressed air generator means is arranged relative to the intermediate store such that fluid is transported initially from the intermediate store into the nozzle by means of compressed air flowing through the nozzle compressed air generator means substantially immediately after the compressed air generator means is switched on.

32. Device according to claim 21, wherein the device is formed in such a way that fluid from the reservoir is always fed to the intermediate store before being atomized.

33. Device according to claim 21, wherein the device has a free standing housing, at least one of the compressed air generator and an energy store is arranged at a bottom region of the housing.

34. Device according to claim 21, wherein the device is portable and has a substantially cylindrical shape.

35. Spray head for atomizing a preferably cosmetic fluid, having:
a feed connection for feeding the fluid;
a compressed air connection;
a nozzle, which is arranged above the feed connection and a connection for receiving compressed air for atomizing the fluid in the nozzle, and
an intermediate store for the fluid which is arranged in proximity to the nozzle and is connected to the nozzle, is connected for receiving the fluid via the feed connection, and being formed in such a way that, when compressed air and fluid feed is switched off, a certain amount of fluid remains in the intermediate store.

36. Spray head according to claim 35, wherein a run-out preventer is arranged between the intermediate store and the nozzle for preventing fluid from running out from the intermediate store through the nozzle.

37. Spray head according to claim 36, wherein the run-out preventer comprises a valve which opens automatically by pressure.

38. Spray head according to claim 36, wherein the run-out preventer comprises a dip tube for the fluid in the intermediate store.

39. Spray head according to claim 35, wherein the spray head has one of a check valve and a dip tube for preventing fluid from the intermediate store from flowing back through the feed connection.

40. Spray head according to claim 35, wherein the intermediate store is constructed and arranged relative to the nozzle and compressed air connection such that fluid is transported initially from the intermediate store into the nozzle and atomized by means of compressed air flowing through the nozzle substantially immediately after the compressed air feed is switched on.
